(19) United States
(12) Patent Application Publication
(10) Pub. No.: US 2017/0217133 A1
(43) Pub. Date: Aug. 3, 2017

(54) Floor and Wall Covering Assembly

(71) Applicant: American Aquawood, Inc., Dalton, GA (US)

(72) Inventors: Andrew Jonathan Jordan, Cartersville, GA (US); Hanping Zhu, Dalton, GA (US); Ya Zhang, Aanhui Province (CN)

(21) Appl. No.: 15/417,327

(22) Filed: Jan. 27, 2017

Related U.S. Application Data
(60) Provisional application No. 62/288,090, filed on Jan. 28, 2016.

(51) Int. Cl. B32B 21/08; B32B 37/12; B32B 27/20; E04F 13/08; E04F 15/10; E04F 15/02; E04F 13/16; B32B 7/12; B32B 21/14

(52) U.S. Cl. CPC B32B 21/08; B32B 7/12; B32B 37/12; B32B 27/20; B32B 21/14; E04F 15/107; E04F 15/02038; E04F 13/16; E04F 13/0894; B32B 2419/04; B32B 2255/08; B32B 2307/71; B32B 2307/73

(57) ABSTRACT

A floor and wall covering plank includes sequentially, from bottom to top, a waterproof substrate, an adhesive layer, a veneer layer, a paint protective layer, a UV protective layer. The plank may further include optionally one or more of a padding layer and veneer layer below the waterproof substrate. The edges of the planks are routed to form a click locking system, squared or angled edges, or a tongue and groove configuration for assembling different planks together to form a floor or a wall covering. The waterproof substrate includes, in weight percentage, about 20-50% polymer material such as vinyl containing thermoplastics resin, about 20-50% calcium carbonate filler, and about 3-20% of the wood flour. A method is provided to make the floor and wall covering plank. The method includes extruding the waterproof core substrate.

### CROSS-REFERENCE TO RELATED PATENT APPLICATIONS

This application claims priority to and the benefit of, pursuant to 35 U.S.C. §119(e), U.S. Provisional Patent Application Ser. No. 62/288,090, filed on Jan. 28, 2016, which is incorporated herein in its entirety by reference.

### TECHNICAL FIELD

The present disclosure relates to the field of floor and/or wall covering assemblies and more particularly to an improved floor and/or a wall covering assembly, which provides improved deforming-resistance, bond failure or delamination-resistance, moisture-resistance for subfloor, noise-reduction and minimal pre requirement features.

### BACKGROUND

In the hard surface flooring industry, there is a significant need for a moisture-resistant floor assembly that looks realistic compared to the classic hardwood floor, and can be installed anywhere regardless of the environment's moisture level, and on any subfloor regardless of the flatness or smoothness of the subfloor surface.

Currently available laminate flooring, luxury vinyl tile flooring (also referred to as LVT), or wood polymer composite (WPC) flooring have the problems of: low moisture resistance, containing harmful chemicals, requiring a smooth and level subfloor for installation, intolerance to water seepage, high cost due to high wood content, having size limit for individual plank, and easily being deformed (expansion and contraction) and degummed (bond failure or delamination) between the layers.

Accordingly, there is a need to develop an improved floor or wall assembly system which overcomes the above weaknesses and disadvantages.

### BRIEF SUMMARY OF THE DISCLOSURE

Therefore, the objective of the present disclosure is to provide an improved formulation for rigid and waterproof floor and wall plank, which is intended as a floor plank for forming a floating floor covering or a wall plank for forming a wall covering assembly. According to various preferred embodiments of the disclosure, it offers a solution to overcome many drawbacks of the currently available hard surface floorings, for example: enables the floor planks to be installed over uneven or soft subfloors, keeps the floor planks from expansion and/or contraction, keeps the multilayers of the floor planks from degumming or bond failure, enables larger plank size that reduces numbers of seams between individual planks, therefore protects the subfloor from being exposed to moisture, as well as lower cost compared to commercially available WPC floor coverings.

In another aspect, the present disclosure provides a floor and wall covering system which is economically feasible and convenient to install.

In another aspect, the present disclosure provides a floor and wall covering system that presents consumer preferred real hardwood appearance and comfort for touching.

In another aspect, the present disclosure provides a floor and wall covering system in which the formulation of the waterproof core substrate reduces the setback of delamination between the core substrate and the veneer layer when exposed to excessive heat or direct sunlight.

In another aspect, the present disclosure provides a floor and wall covering system in which the formulation of the waterproof core substrate composition reduces the problem of expansion and contraction of the core substrate when exposed to unwarranted impacts.

In another aspect, the present disclosure provides a floor and wall covering system having improved and reduced noise transmission levels.

In another aspect, the present disclosure provides a floor and wall covering system that has great flexibility so as to make various sizes and shapes, which subsequently reduces numbers of seams between individual planks, and improves subfloor moisture damage resistance.

In another aspect, the present disclosure provides a floor and wall covering system which has the ability to tolerate subfloor imperfections and avoid lining out or migrating of the unevenness on the floor and wall covering itself.

Additional features and advantages of the present disclosure will be set forth in the description which follows, and in part will be apparent from the description, or may be learned by practice of the present disclosure. The features and other advantages of the present disclosure will be realized and attained by means of the elements and combinations particularly pointed out in the written description and appended claims.

To achieve these and other advantages and in accordance with the purpose of the present disclosure, as embodied and broadly described herein, in one aspect, the present disclosure relates to a floor and wall covering plank, wherein the floor and wall covering plank comprises a waterproof core substrate comprising up to 40% vinyl containing thermoplastics resin, up to 40% calcium carbonate filler, up to 10% of wood flour, up to 15% stabilizers, lubricants and intensifier, wherein the waterproof core substrate has an upper surface and a lower surface, and a pair of longitudinal opposite edges; an adhesive layer affixed to the upper surface of the waterproof core substrate, wherein the adhesive layer has an upper surface and a lower surface, wherein the adhesive layer further comprises hot melt adhesive; a veneer layer affixed to the upper surface of the adhesive layer, wherein the veneer layer has an upper surface and a lower surface, wherein the veneer layer is made from real wood, wherein the veneer layer has a thickness of from about 0.04 mm to about 8.0 mm; a paint protective layer affixed to the upper surface of the veneer layer, wherein the paint protective layer has an upper surface and a lower surface; and an ultraviolet (UV) protective layer affixed to the upper surface of the paint protective layer, wherein the UV protective layer has an upper surface and a lower surface, wherein the UV protective layer is able to absorb UV radiation; wherein the waterproof core substrate has a thickness of from about 2.0 mm to about 18.0 mm, a width of from about 2.5 cm to about 275.0 cm, and a length of from about 15.0 cm to about 400.0 cm; and wherein the waterproof core substrate at the pair of longitudinal opposite edges is routed into a coupling system, allowing to couple two such floor and wall covering planks to each other.

Preferably, the waterproof core substrate has a thickness of 8.0 mm.

Preferably, the veneer layer has a thickness of 1.2 mm.

Preferably, a solution is offered for the real hardwood appearance of the floor planks from the state of the art. By having a paint layer on top of the surface of the real hardwood veneer layer, both cosmetic effect and wear protection can be achieved.

In another aspect, the waterproof core substrate preferably is obtained by mixing 39% of the vinyl containing thermoplastics resin, 39% calcium carbonate filler, 8% of wood flour, 14% stabilizers, lubricants and intensifier. Such a formulation results in a harder substrate, wherein permanent impressions can be minimized. By means of the thermoplastic substrate near to or on the surface of the floor panel, a solution is offered for the occurrence of excessive ticking noises. Moreover, the rigid substrate avoids the lining out or migrating of unevennesses of the underlying surface towards the upper layer.

In another aspect, the lower surface of the waterproof core substrate may be left uncovered or optionally a padding can be affixed thereto. The padding can be cork, EVA, PPI, IXPE, XPS, or any other rubber/foam/plastic, or petro-chemical based backing. The pad serves as a leveling device, a cushioning device, a non-skid device, and/or a combination of the above-listed or other functions.

In another aspect, the present disclosure further relates to a method of making a floor and wall plank and involves the steps of mixing wood and polymer materials under a high-temperature, cooling down, and then continuously extruding at a temperature of between 145-195° C., into the shape of a waterproof core substrate, wherein the floor and wall plank comprises a veneer layer affixed to the upper surface of the waterproof core substrate, a paint protective layer affixed to the upper surface of the veneer layer, an ultraviolet (UV) protective layer affixed to the upper surface of the paint protective layer, and optionally a padding affixed to the lower surface of the waterproof core substrate.

The present disclosure also relates to floor and wall covering planks having the above-described characteristics.

It is to be understood that both the forgoing general description and the following detailed description are exemplary and explanatory only and are intended to provide further explanation of the present disclosure, as claimed,

### BRIEF DESCRIPTION OF THE DRAWINGS

Hereinafter, the embodiments of the present disclosure are illustrated in conjunction with drawings, wherein:

FIG. 1 is a three-dimensional exploded view of a plank according to one embodiment of the present disclosure.

FIG. 2 is a side view of a plank according to one embodiment of the present disclosure.

FIG. 3 is an upper view of a plank according to one embodiment of the present disclosure.

FIG. 4 is an upper front three-dimensional view of a plank according to one embodiment of the present disclosure.

FIG. 5 is diagram showing a method for making a plank according to one embodiment of the present disclosure.

### DETAILED DESCRIPTION OF THE DISCLOSURE

The disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. maybe used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “lower” and “upper” or “upper,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about” “substantially” or “approximately” can be inferred if not expressly stated.

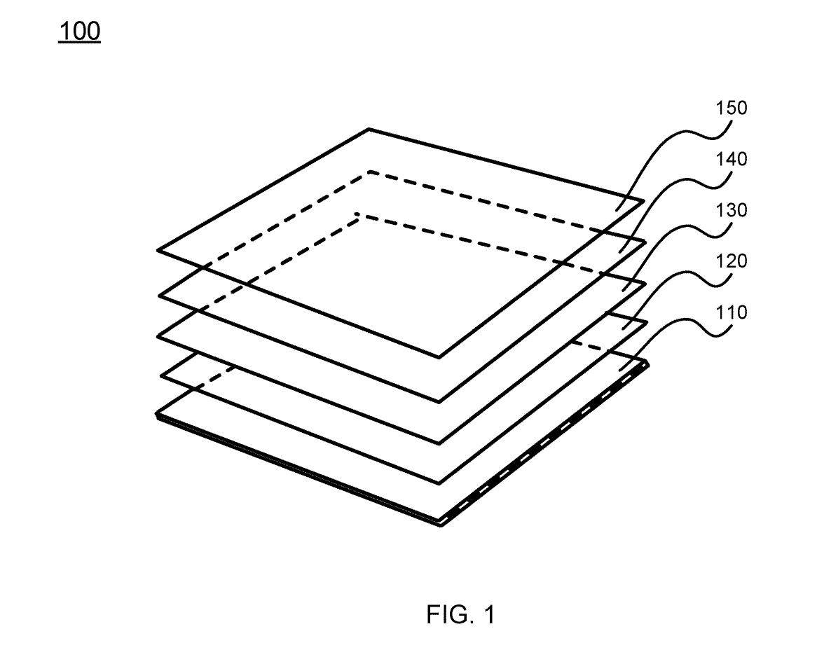

The description will be made as to the embodiments of the disclosure in conjunction with the accompanying drawings in FIGS. 1-5. In accordance with the purposes of this disclosure, as embodied and broadly described herein, this disclosure, in one aspect, relates to a plank.

FIG. 1 is a three-dimensional exploded view of a plank according to one embodiment of the present disclosure. As shown in FIG. 1, a plank 100 includes a waterproof core substrate 110, an adhesive layer 120 affixed to the upper surface of the waterproof core substrate 110, a veneer layer 130 disposed above the adhesive layer 120, a paint protective layer 140 applied on the upper surface of the veneer layer 130, and an ultraviolet (UV) protective layer 150 affixed to the upper surface of the paint protective layer 140.

In certain embodiments, the waterproof core substrate 110 includes, in weight percentage, about 20-50% vinyl containing thermoplastics resin. in certain embodiments, the waterproof core substrate includes up to 40% vinyl containing thermoplastics resin. In one example, the waterproof core substrate includes about 39% of the vinyl containing thermoplastics resin. The vinyl containing thermoplastics resin may include, but are not limited to, vinyl containing thermoplastics such as polyvinyl chloride (PVC), polyvinyl acetate, polyvinyl alcohol, and other vinyl and vinylidene resins and copolymers thereof; polyethylenes such as low density polyethylenes and high density polyethylenes and copolymers thereof; styrenes such as ABS, SAN, and polystyrenes and copolymers thereof; polypropylene and copolymers thereof; saturated and unsaturated polyesters; acrylics; polyamides such as nylon containing types; engineering plastics such as acetyl, polycarbonate, polyimide, polysulfone, and polyphenylene oxide and sulfide resins and the like, or the combinations of one or more materials described above. In one example, the vinyl containing thermoplastics resin is a rigid polyvinyl chloride (PVC). In certain embodiments, the vinyl containing thermoplastics resin includes a suspension grade or mass polymerization grade homopolymer resin. In certain embodiments, the vinyl containing thermoplastics resin to be processed can be in powder, liquid, cubed, pelletized form and/or any other extrudable form. Further, the vinyl containing thermoplastics resin can be virgin, recycled, or a mixture of both.

In certain embodiments, the composition of the waterproof core substrate 110 includes, in weight percentage, about 20-50% of calcium carbonate. In certain embodiments, the composition of the waterproof core substrate 110 includes up to 40% calcium carbonate. In certain embodiments, the composition of the waterproof core substrate 110 includes about 39% calcium carbonate. The calcium carbonate added at this range, among other things, increases rigidity of the waterproof core substrate 110, and is an important requirement for operations at high temperatures.

The composition of the waterproof core substrate 110 further includes wood flour, such as wood powders of different sizes. In certain embodiments, the composition of the waterproof core substrate 110 includes about 3-20% of the wood flour or mixture of wood powders. In certain embodiments, the waterproof core substrate includes up to 10% of wood powder or a mixture of wood powders. In one embodiment, the composition of the waterproof core substrate 110 includes about 8% of wood powder or a mixture of wood powders.

In addition to a typical wood powder and PVC mixture, the waterproof core substrate 110 according to certain embodiments of the present disclosure can also include other additives. The additives include, but are not limited to, impact modifiers, stabilizers, lubricants, processing aids, foaming agents, preservatives, coupling agents, other conventional additives, and the like, or the combinations of one or more materials described above. In certain embodiments, the waterproof core substrate 110 includes about 1-20% stabilizers, lubricants and intensifier. In certain embodiments, the waterproof core substrate 110 includes up to 15% stabilizers, lubricants and intensifier. In certain embodiments, the waterproof substrate 110 includes about 14% stabilizers, lubricants and intensifier.

In certain embodiments, the waterproof core substrate 110 includes, in weight percentage, about 20-50% vinyl containing thermoplastics resin, about 20-50% calcium carbonate filler, and about 3-20% of the wood flour. In certain embodiments, the waterproof core substrate 110 includes about 30-40% vinyl containing thermoplastics resin, about 30-40% calcium carbonate filler, and about 5-10% of the wood flour. The waterproof substrate may further include about 1-20% stabilizers, lubricants and intensifier.

In certain embodiments, the waterproof substrate includes up to 40% vinyl containing thermoplastics resin, up to 40% calcium carbonate filler, up to 10% of wood flour, and up to 15% stabilizers, lubricants and intensifier.

In one example, the waterproof core substrate 110 has the following formula where the percentage is the weight percentage:

| | WEIGHT |
|---|---|
| | PERCENTAGE |
| FORMULATION | (%) |
| Extrusion Grade PVC | 39 |
| Calcium carbonate filler | 39 |
| Wood flour | 8 |
| Stabilizers, lubricants, | 14 |
| intensifier package | |

The high concentration of vinyl containing thermoplastic resin, high concentration of calcium carbonate, and lower concentration of wood flour give the composed plank many beneficial advantages. For example, the strength of the waterproof core substrate 110 is high, which makes cutting and using plank 100 with larger size possible, which, in turn reduces numbers of seams and protects subfloor from moisture damage; the expansion and/or contraction such as thermal expansion and/or contraction of the waterproof core substrate 110 matches that of the veneer layer 130, so that the waterproof core substrate 110 and the veneer layer 130 are bonded securely by the adhesive layer 120, and not easy to delaminated from each other.

In certain embodiments, the waterproof core substrate 110 has a thickness of from about 2.0 mm to about 18.0 mm, a width of from about 2.5 cm to about 275.0 cm, and a length of from about 15.0 cm to about 400.0 cm.

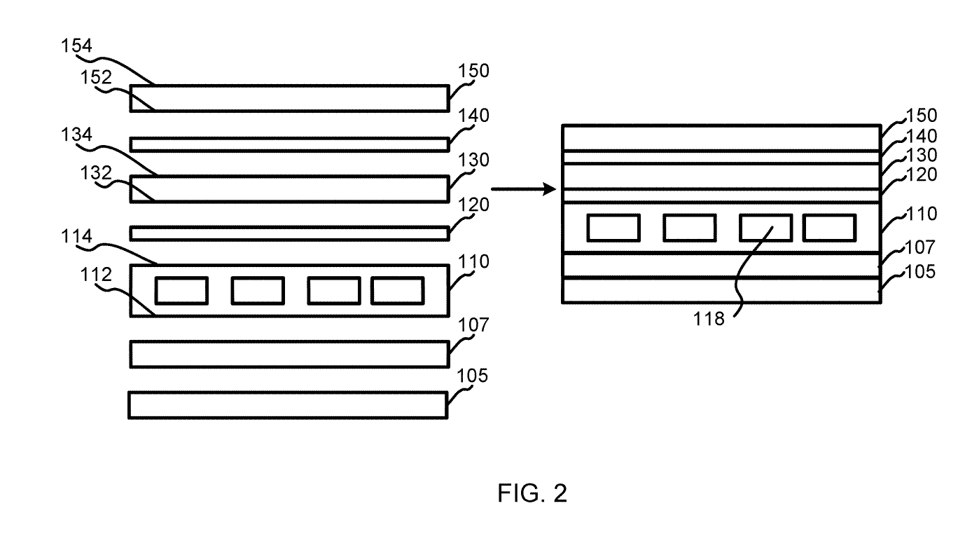

As shown in FIG. 2, the waterproof core substrate 110 has a lower surface 112 and an upper surface 114. Referring to FIGS. 1 and 2, the adhesive layer 120 is affixed to the upper surface 114 of the waterproof core substrate 110. In certain embodiments, the adhesive layer 120 is evenly distributed on the upper surface 114 of the waterproof core substrate 110 before attaching the veneer layer 130 to the adhesive layer 120. In certain embodiments, the adhesive layer includes a hot melt adhesive. In one example, the hot melt adhesive is pre-attached to the upper surface 114, and the veneer layer 130 is attached from above the waterproof substrate 110 by a heating operation on the upper surface 114, such that the hot melt adhesive securely bonds the veneer layer 130 to the waterproof core substrate 110.

As shown in FIG. 2, the veneer layer 130 has a lower surface 132 and an upper surface 134 and the lower surface 132 of the veneer layer 130 is attached to the adhesive layer 120. In certain embodiments, the hot melt adhesive may also be applied to the lower surface 132 of the veneer layer 130 first, and then the lower surface 132 of the veneer layer 130 is heated and then attached to the upper surface 114 of the waterproof core substrate 110. In certain embodiments, the veneer layer 130 has a thickness of from about 0.04 mm to about 8.0 mm. In one example, the veneer layer has a thickness of about 1.2 mm. In certain embodiments, the veneer layer 130 is made from real hardwood including, but not limited to, oak, white oak, chestnut, maple, black walnut, etc.

The paint protective layer 140 is affixed to the upper surface 134 of the veneer layer 130. In certain embodiments, the paint protective layer 140 is painted on the upper surface 134 after the veneer layer 130 is bonded with the waterproof core substrate layer 110. In other embodiments, the paint protective layer 140 may be painted on the veneer layer 130 in advance, and the painted veneer layer 130 is then bonded to the waterproof core substrate 110.

In certain embodiments, the plank 100 further includes the UV protective layer 150. The UV protective layer 150 has a lower surface 152 and an upper surface 154. The lower surface 152 of the UV protective layer 150 is affixed to the paint protective layer 140. In certain embodiments, the plank 100 may not include the UV protective layer 150, and the paint protective layer 140 is the top layer of the plank 100. In other embodiments, the plank 100 may include other types of protective layers instead of the UV protective layer 150.

In certain embodiments, at least one of the adhesive layer 120, the paint protective layer 140, and the UV protective layer 150 is a transparent layer or a translucent layer. For example, when the UV protective layer 150 is transparent or translucent, the pattern and color of the paint protective layer 140 can be seen from outside for aesthetic purpose.

In certain embodiments, as shown in FIG. 2, the plank 100 may further include a padding 105 disposed under the waterproof substrate 110. The padding 105 can be cork, EVA, PPI, IXPE, XPS, or any other rubber/foam/plastic, or petro-chemical based backing. The padding 105 serves as a leveling device, a cushioning device, a non-skid device, and/or a combination of the above-listed or other functions. In certain embodiments, an adhesive layer is disposed between the padding 105 and the waterproof core substrate 110 to securely bond the two together.

In certain embodiments, as shown in: FIG. 2, the plank 100 may further include a lower veneer layer 107 disposed between the waterproof core substrate 110 and the padding 105. The lower veneer layer 107 may have the same structure as the veneer layer 130. The lower veneer layer 107 may be bonded to the waterproof core substrate 110 and the padding 105 through an adhesive, such as the adhesive 120.

In certain embodiments, the waterproof core substrate 110 may have the lower veneer layer 107 but not the padding layer 105, and the lower veneer layer 107 is attached to the lower surface of the waterproof core substrate 110 through an adhesive, such as the adhesive 120.

In certain embodiments, the layers above the waterproof core substrate 110 and the layers below the waterproof core substrate 110 are the same and disposed symmetrical at two sides of the substrate 110. In one example, the plank 100 includes the waterproof core substrate 110, the veneer layer 130 bonded to the upper surface of the waterproof substrate 110 using the adhesive 120, and the lower veneer layer 107 bonded to the lower surface of the waterproof substrate 110 using the adhesive different from or the same as the adhesive 120.

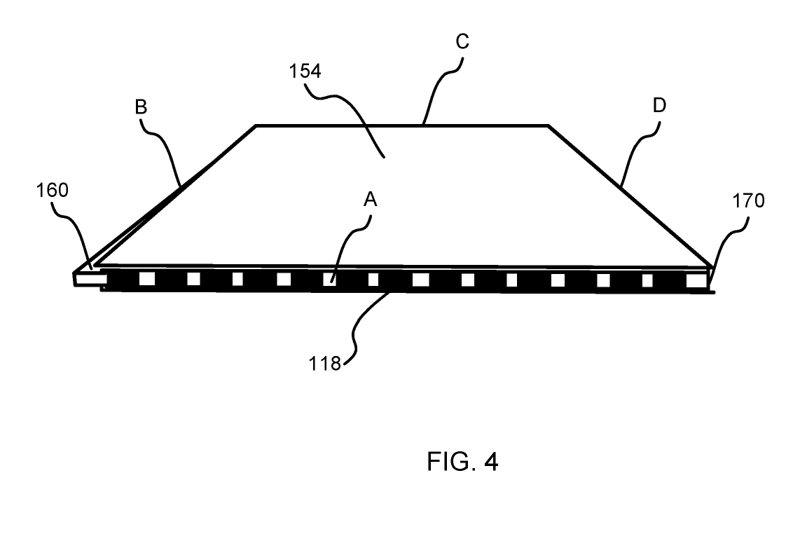

In certain embodiments, the waterproof core substrate 110 is solid. In other embodiments, as shown in FIG. 2, the waterproof core substrate 110 can have one or more cavities or cells 118 which are located between the lower surface 112 and the upper surface 114 of the waterproof core substrate 110. In certain embodiments, the cavities 118 disposed in the waterproof core substrate 110 function to reduce the amount of materials used, create a lighter weight product, and improve sound-resistance. The cavities or cells 118, which can be part of the extruded core, preferably have dimensions of from about 3.8 mm to about 4.5 mm in height, and from about 9.0 mm to about 10.5 mm in width. In certain embodiments, the optimal dimension of cavities 118 depends on the requirement of the product withstanding the potential impact force of falling objects. The cavities 118 which are preferably present can be any shape such as rounded, oval, or rectangular. These cavities or cells 118 preferably exist across the entire dimensions of the waterproof core substrate 110 as shown in FIGS. 2 and 4. In certain embodiments the cavities 118 are configured such that wires, cables, fiber optics, and/or piping can be run through the cavities 118 which make installation of wiring and piping quite easy without the necessity of drilling holes through walls, or running wires underneath the floor.

The finished products, with or without the padding 105, are cut into planks with a width from approximately 2.5 cm to 275.0 cm, and a length of from approximately 15.0 cm to 400.0 cm. These lengths and widths can vary depending on the use to which the product will be put and the capacity of the production machinery and facilities.

The plank 100 may further include a coupling mechanism for joining multiple planks 100 to form a large flat space such as a floor. The coupling mechanism joins adjacent planks to create a tight seal at each seam. In certain embodiments, the edges of the planks may be routed to form a click locking system, squared or angled edges, or a tongue and groove configuration. The click locking systems may be, for example, Vilinge, Unilin, Arch-Angle, Tap n Go, drop-lock, or other suitable systems.

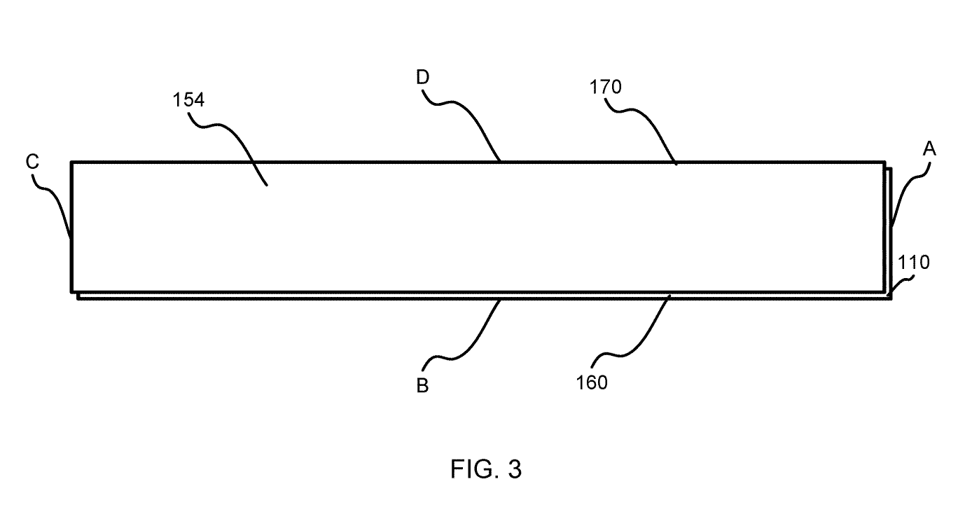

In certain embodiments, as shown in FIGS. 3 and 4, the coupling mechanism may be achieved by aligning the layers of the plank 100 in a staggered manner. In one embodiment, the waterproof core substrate 110 may have a protrusion portion and a recess portion relative to other layers of the plank 100, and the protrusion portion of the waterproof core substrate 110 of one plank may be inserted to the recess portion of the waterproof core substrate 110 of another plank, so as to connect the two planks together. The connection using the waterproof core substrate 110 ensures that the entire assembled floor, wall, etc. is waterproof.

Specifically, referring to FIGS. 3 and 4, the plank 100 has a first side A, a second side B adjacent to the first side A, a third side C adjacent to the second side B, and a fourth side D connecting the third side C and the first side A. The coupling mechanism may include a male member or the first locking member 160 and a female member or a second locking member 170. The first locking member 160 is located at the first and second sides A and B, which are protrusions formed by extending the edges of the waterproof substrate 110 beyond the corresponding edges of the veneer layer 130, the corresponding edges of the UV protective layer 150 and optionally the corresponding edges of the padding 105. The second locking member 170 is located at the third and fourth sides C and D, which are recessions of the waterproof core substrate 110 relative to the edges of the veneer layer 130 and optionally the padding 105. The first locking member 160 of one plank can thus be inserted into the second locking member 170 of another plank, so as to connect the two planks together.

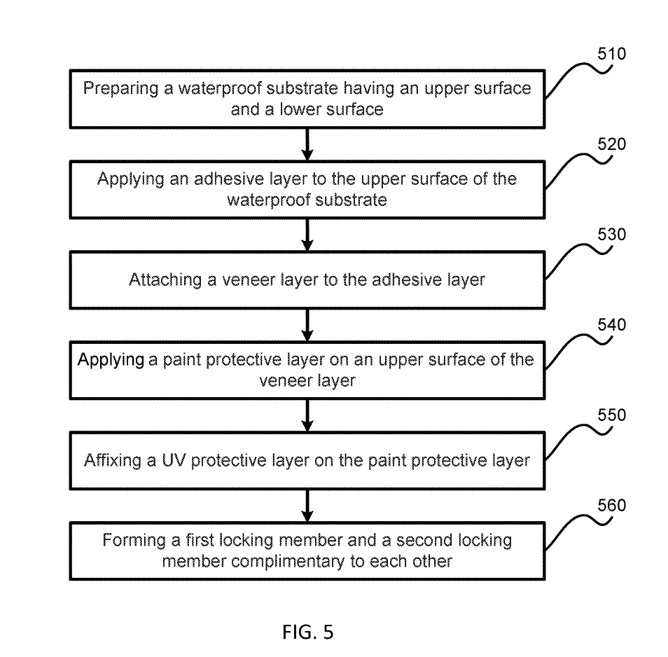

In another aspect, the present disclosure provides a method for making a plank 100. In certain embodiments, as shown in FIG. 5, the method includes the following steps.

At step 510, a waterproof core substrate 110 is prepared. The waterproof core substrate 110 may have the composition and size as described above. In certain embodiments, the waterproof core substrate 110 is extruded using the formulation of wood and plastic materials as described above. Specifically, the wood, the plastic material, and the additives, with the formulations described above, are mixed under high temperature to have a mixture where each component is evenly distributed, the mixture is cooled down to a certain temperature, and then is continuously extruded at a temperature of between 145-195° C. into a waterproof core substrate in a desired shape.

At step 520, an adhesive layer 120 is applied to the upper surface 114 of the waterproof core substrate 110. The adhesive may be a hot melt adhesive. The adhesive may be spread on the upper surface 114. In other embodiments, the adhesive layer 120 may also be applied to the veneer layer 130 in advance.

At step 530, a veneer layer 130 is bonded to the waterproof core substrate 110 through the adhesive layer 120. The bonding process may be achieved by heat treatment to melt the hot melt adhesive 120.

At step 540, a paint protective layer 140 is painted on the veneer layer 130. In other embodiments, the paint protective layer 140 may be painted on the veneer layer 130 in advance.

In certain embodiments, the method further includes step 550. At step 550, a UV protective layer is fixed to the paint protective layer 140.

In certain embodiments, the method may further include attaching a lower veneer layer 107 to the lower surface of the waterproof core substrate 110 using an adhesive.

In certain embodiments, the method may further include attaching a padding layer 105 to the lower surface of the waterproof core substrate 110 using an adhesive.

In certain embodiments, the method may further include attaching a lower veneer layer 107 to the lower surface of the waterproof core substrate 110 using an adhesive, and attaching a padding layer 105 to a lower surface of the lower veneer layer 107.

Each adhesive used for attaching the lower veneer layer 107 and the padding layer 105 may be the same as or different from the adhesive 120.

In certain embodiments, the plank 100 made by the above method may include the waterproof core substrate 110 in the center, and two veneer layers 130 and 107 attached to the two sides of the waterproof core substrate 110. This plank 100 thus has a symmetrical sandwiched structure, which are used in the field for certain purposes.

In certain embodiments, the method further includes step 560. At step 560, a locking mechanism is formed. The locking mechanism may include the first locking member 160 and a second locking member 170. In certain embodiments, the method may not include this specific step, and the locking members 160 and 170 are formed, for example during the steps 510-550, by aligning the different layers of the plank 100 in a way such that the waterproof core substrate 110 has two sides protruded and two sides recessed relative to, for example the veneer layer 130.

In certain embodiments, the above steps are performed sequentially. In other embodiments, the above steps may be performed in any sequence that is appropriate. For example, the waterproof core substrate 110 may be applied with the adhesive layer 120 in advance, the paint protective layer 140 may be applied to the upper surface 134 of the veneer layer 130 in advance, or the adhesive layer 120 may be applied to the lower surface 132 of the veneer layer 130 in advance before bonding to the waterproof core substrate 110.

In certain embodiments, the waterproof core substrate 110 is formed of up to 40% of vinyl containing thermoplastics resin, up to 40% of calcium carbonate filler, up to 10% of wood flour, and up to 15% of stabilizers, lubricants and intensifier. In certain embodiments, the waterproof substrate 110 is formed of 39% of the vinyl containing thermoplastics resin, 39% of the calcium carbonate filler, 8% of the wood flour, and 14% of the stabilizers, lubricants and intensifier. In certain embodiments, the waterproof core substrate 110 has a thickness of about 2.0-18.0 mm, a width of about 2.5-275.0 cm, and a length of about 15.0-400.0 cm.

In certain embodiments, the adhesive layer 120 includes a hot melt adhesive.

In summary, a plank according to certain embodiments of the present disclosure has the following beneficial advantages.

1. By the specific composition of the plank of the present disclosure, the plank is resistant to moisture, easy to install, and resistant to deformation (expansion and contraction) and degumming (failure to bond).

2. By having a proper amount of a rigid polyvinylchloride (PVC) in the substrate layer of the plank, the cost is saved and tendency to cup due to high content of PVC is avoided.

3. The plank of the present disclosure has sufficient strength to maintain a larger individual size, which makes the installation process convenient and easy, reduces numbers of seams and protects subfloor from moisture damage.

4. The expansion rate of the waterproof core substrate matches that of the veneer layer, thus avoiding deformation and degumming of the plank.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. A plank comprising:
a waterproof core substrate having an upper surface and a lower surface;
an adhesive layer affixed to the upper surface of the waterproof core substrate;
a veneer layer having an upper surface and a lower surface, the lower surface of the veneer layer being disposed above the adhesive layer; and
a paint protective layer having an upper surface and a lower surface, the lower surface of the paint protective layer being affixed to the upper surface of the veneer layer,
wherein the waterproof core substrate comprises, in weight percentage, about 20-50% vinyl containing thermoplastics resin, about 20-50% calcium carbonate filler, and about 3-20% wood flour.

2. The plank of claim 1, wherein the waterproof core substrate comprises about 30-40% of the vinyl containing thermoplastics resin, about 30-40% of the calcium carbonate filler, about 5-10% of the wood flour, and about 1-20% stabilizers, lubricants and intensifier.

3. The plank of claim 2, wherein the waterproof core substrate comprises about 39% of the vinyl containing thermoplastics resin, about 39% of the calcium carbonate filler, about 8% of the wood flour, and about 14% of the stabilizers, lubricants and intensifier.

4. The plank of claim 1, further comprising a lower veneer layer affixed to the surface of the waterproof core substrate.

5. The plank of claim 1, further comprising an UV protective layer affixed to the upper surface of the paint protective layer.

6. The plank of claim 1, wherein the waterproof substrate has a thickness of about 2.0-18.0 millimeter (mm), a width of about 2.5-275.0 centimeter (cm), and a length of about 15.0-400.0 centimeter (cm).

7. The plank of claim 6, wherein the thickness of the waterproof substrate is about 8.0 mm.

8. The plank of claim 1, wherein the adhesive a r comprises a hot melt adhesive.

9. The plank of claim 1, wherein the veneer layer has a thickness of about 0.04-8.0 mm.

10. The plank of claim 9, wherein the thickness of the veneer layer is about 1.2 mm.

11. The plank of claim 1, wherein the waterproof core substrate forms a first locking member and a second locking member complimentary to each other, such that when being assembled, the first locking member of one plank is configured to engage with a second locking member of a neighboring plank.

12. A method of manufacturing a plank, comprising:
preparing a waterproof core substrate having an upper surface and a lower surface, wherein the preparation involves steps of mixing wood flour, calcium carbonate filler and vinyl containing thermoplastics resin under a high temperature, cooling down and then continuously extruding at a temperature of between 145-195° C. into the waterproof core substrate having a predetermined shape;
applying an adhesive layer to the upper surface of the waterproof core substrate;
attaching a veneer layer to the adhesive layer, wherein the veneer layer has an upper surface and a lower surface, and the lower surface of the veneer layer is attached with the adhesive layer; and
applying a paint protective layer on the upper surface of the veneer layer,
wherein the waterproof substrate comprises, in weight percentage, about 20-50% of the vinyl containing thermoplastics resin, about 20-50% of the calcium carbonate filler, and about 3-20 of the wood flour.

13. The method of claim 12, wherein the waterproof core substrate comprises about 30-40% of the vinyl containing thermoplastics resin, about 30-40% of the calcium carbonate filler, about 5-10% of the wood flour, and about 1-20% stabilizers, lubricants and intensifier.

14. The method of claim 13, wherein the waterproof core substrate comprises about 39% of the vinyl containing thermoplastics resin, about 39% of the calcium carbonate filler, about 8% of the wood flour, and about 14% of the stabilizers, lubricants and intensifier.

15. The method of claim 12, further comprising affixing a UV protective layer on the paint protective layer.

16. The method of claim 12, wherein the waterproof core substrate has a thickness of about 2.0-18.0 mm, a width of about 2.5-275.0 cm, and a length of about 15.0-400.0 cm, and wherein the veneer layer has a thickness of about 0.04-8.0 mm.

17. The method of claim 16, wherein the thickness of the waterproof core substrate is about 8.0 mm, and the thickness of the veneer layer is about 1.2 mm.

18. The method of claim 12, further comprising forming a first locking member and a second locking member complimentary to each other, wherein the first and second locking members are portions of the waterproof core substrate, wherein when the plank is assembled, the first locking member of one plank is configured to engage with the second locking member of a neighboring plank.

19. A waterproof core substrate for making a plank, comprising in weight percentage, about 20-50% polymer material, about 20-50% calcium carbonate filler, and about 3-20% of the wood flour.

20. The waterproof core substrate of claim 19, comprising about 30-40% of the polymer material, about 30-40% of the calcium carbonate filler, about 5-10% of the wood flour, and about 1-20% stabilizers, lubricants and intensifier.

21. The waterproof core substrate of claim 20, comprising about 39% of the polymer material, about 39% of the calcium carbonate filler, about 8% of the wood flour, and about 14% of the stabilizers, lubricants and intensifier, and the polymer material comprises vinyl containing thermoplastics resin.
